(19) United States
(12) Patent Application Publication
(10) Pub. No.: US 2025/0254613 A1
(43) Pub. Date: Aug. 7, 2025

(54) MEDIUM PROTECTION DURING DYNAMIC POWER SAVING OPERATION

(71) Applicant: Samsung Electronics Co., Ltd., Suwon-si (KR)

(72) Inventors: Vishnu Vardhan Ratnam, Plano, TX (US); Bilal Sadiq, Frisco, TX (US); Boon Loong Ng, Plano, TX (US); Rubayet Shafin, Allen, TX (US); Peshal Nayak, Plano, TX (US); Yue Qi, Plano, TX (US)

(21) Appl. No.: 19/038,131

(22) Filed: Jan. 27, 2025

Related U.S. Application Data
(60) Provisional application No. 63/548,702, filed on Feb. 1, 2024.
(60) Provisional application No. 63/715,249, filed on Nov. 1, 2024.

(51) Int. Cl. H04W 52/02; H04W 74/0816

(52) U.S. Cl. CPC H04W 52/0206; H04W 74/0816

(57) ABSTRACT

An embodiment includes an access point (AP) that can perform state transitions while operating in dynamic power save, whereby the AP determines that it is able to transition between reduced and enhanced operating parameter states while not causing loss of medium synchronization at the AP and while preventing loss of frames, including by either transmitting a frame to itself to set a duration that is sufficient to perform the state transition or by requesting assistance from a station (STA) in order to perform the state transition, or by identifying an ongoing transmission not addressed to the AP during which the transition can be performed.

CROSS-REFERENCE TO RELATED APPLICATION(S)

This application claims the benefit of priority from U.S. Provisional Application No. 63/548,702, entitled “MEDIUM PROTECTION DURING DYNAMIC POWER SAVING OPERATION AT AN AP” filed Feb. 1, 2024; and U.S. Provisional Application No. 63/715,249, entitled “MEDIUM PROTECTION DURING DYNAMIC POWER SAVING OPERATION AT AN AP” filed Nov. 1, 2024, all of which are incorporated herein by reference in their entireties.

### TECHNICAL FIELD

This disclosure relates generally to a wireless communication system, and more particularly to, for example, but not limited to, medium protection during dynamic power saving (DPS) operations at an access point (AP) in a wireless network.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) in a wireless network, comprising a memory; and a processor coupled to the memory. The processor is configured to operate in a first state of a dynamic power saving mode. The processor is configured to determine a capability to transition to a second state of the dynamic power saving mode. The processor is configured to transition to the second state of the dynamic power saving mode during a network allocation vector (NAV) duration.

In some embodiments, the first state is a reduced operating parameter state and the second state is an enhanced operating parameter state; the first state is the enhanced operating parameter state and the second state is the reduced parameters state; or the first state is a reduced operating parameter state without transmit capability and the second state is a reduced operating parameter state with transmit capability.

In some embodiments, the processor is further configured to detect a preamble of a frame that is not addressed to the AP and the NAV duration is associated with the frame.

In some embodiments, the processor is further configured to transmit a frame to set the NAV for at least a time period required to transition to the second state.

In some embodiments, the processor is further configured to transmit, to a station (STA), a first frame indicating that the AP intends to transition from the first state to the second state; and receive, from the STA, a second frame in response to the first frame, the second frame including a padding, wherein the AP transitions to the second state on or before an end of the padding.

In some embodiments, the processor is further configured to: receive, from a station (STA), a frame that includes a padding, wherein the AP transitions to the second state on or before an end of the padding.

In some embodiments, the frame is transmitted on a full bandwidth of a transmission opportunity (TXOP) or on a primary 20 MHz bandwidth of the TXOP.

In some embodiments, the processor is further configured to transmit, to the STA, an acknowledgement frame in response to the frame.

In some embodiments, the processor is further configured to apply one or more transmission parameters associated with a current state to which the AP belongs.

One aspect of the present disclosure provides a station (STA) in a wireless network, comprising: a memory; and a processor coupled to the memory. The processor is configured to receive, from an access point (AP), a first frame indicating that the AP intends to transition from a first state to a second state of a dynamic power saving mode. The processor is configured to transmit, to the AP, a second frame in response to the first frame, the second frame including padding, wherein the AP transitions to the second state on or before an end of the padding.

In some embodiments, the processor is further configured to transmit, to the AP, a third frame to indicate one or more of a capability of supporting dynamic power saving operation at the AP; and a capability of transmitting frames for providing medium protection for the AP's dynamic power saving state transitions.

In some embodiments, the processor is further configured to: receive, from the AP, an acknowledgement frame in response to the second frame.

One aspect of the present disclosure provides a computer-implemented method for wireless communication by an access point (AP) in a wireless network. The method comprises operating in a first state of a dynamic power saving mode. The method comprises determining a capability to transition to a second state of the dynamic power saving mode. The method comprises transitioning to the second state of the dynamic power saving mode during a network allocation vector (NAV) duration.

In some embodiments, the first state is a reduced operating parameter state and the second state is an enhanced operating parameter state, the first state is the enhanced operating parameter state and the second state is the reduced parameters state, or the first state is a reduced operating parameter state without transmit capability and the second state is a reduced operating parameter state with transmit capability.

In some embodiments, the method further comprises detecting a preamble of a frame that is not addressed to the AP and the duration is associated with the frame.

In some embodiments, the method further comprises transmitting a frame to set the NAV for at least a time period required to transition to the second state.

In some embodiments, the method further comprises transmitting, to a station (STA), a first frame indicating that the AP intends to transition from the first state to the second state; and receiving, from the STA, a second frame in response to the first frame, the second frame including a padding, wherein the AP transitions to the second state on or before an end of the padding.

In some embodiments, the method further comprises receiving, from a station (STA), a frame that includes a padding, wherein the AP transitions to the second state on or before an end of the padding.

In some embodiments, the frame is transmitted on a full bandwidth of a transmission opportunity (TXOP) or on a primary 20 MHz bandwidth of the TXOP.

In some embodiments, the method further comprises transmitting, to the STA, an acknowledgement frame in response to the frame.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an EHT Capabilities element in accordance with an embodiment.

FIG. 5 illustrates an example of an uplink frame exchange by a STA with an AP operating in DPS mode in accordance with an embodiment.

FIG. 6 illustrates a generic scenario whereby an AP operates a Basic Service Set (BSS) with several associated STAs in accordance with an embodiment.

FIG. 7A illustrates the use of a transmission opportunity (TXOP) not addressed to the AP for performing the transition from reduced operating parameters to enhanced operating parameters in accordance with an embodiment.

FIG. 7B illustrates use of a TXOP not addressed to the AP for performing the transition from enhanced operating parameters to reduced operating parameters in accordance with an embodiment.

FIG. 8A illustrates protection of the medium for the transition from reduced to enhanced operating parameters as a TXOP owner using clear-to-send (CTS)-to-self in accordance with an embodiment.

FIG. 8B illustrates protection of the medium for the transition from enhanced to reduced operating parameters as a TXOP owner using clear-to-send (CTS)-to-self frame in accordance with an embodiment.

FIG. 9A illustrates protection of the medium for the transition from reduced to enhanced operating parameters in a downlink TXOP using assistance from a STA in accordance with an embodiment.

FIG. 9B illustrates protection of the medium for the transition from enhanced to reduced operating parameters in a downlink TXOP using assistance from a STA in accordance with an embodiment.

FIG. 9C illustrates the protection of medium for transition from enhanced to reduced operating parameters after downlink transmission using an un-triggered transmission by a non-AP STA in accordance with an embodiment.

FIG. 10 illustrates an indication by the AP in DPS mode of its intention to transition to another DPS state in an A-control field in accordance with an embodiment.

FIG. 11A illustrates protection of medium for transition back to reduced operating parameters after uplink transmission using a follow-up frame in accordance with an embodiment.

FIG. 11B illustrates the protection of medium for transition back to reduced operating parameters after uplink transmission using padding in accordance with an embodiment.

FIG. 12A illustrates the protection of medium for transition from reduced to enhanced operating parameters after uplink transmission in accordance with an embodiment.

FIG. 12B illustrates the protection of medium for transition from reduced to enhanced operating parameters after uplink transmission in accordance with an embodiment.

FIG. 13 illustrates a flow chart of an example process of an AP when performing DPS state transition in accordance with an embodiment.

FIG. 14 illustrates a flow chart of an example process performed by an STA when the AP performs DPS state transitions in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

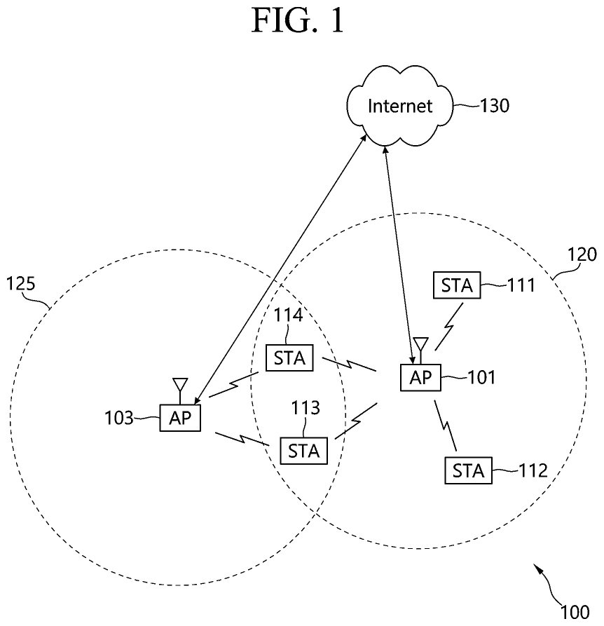

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

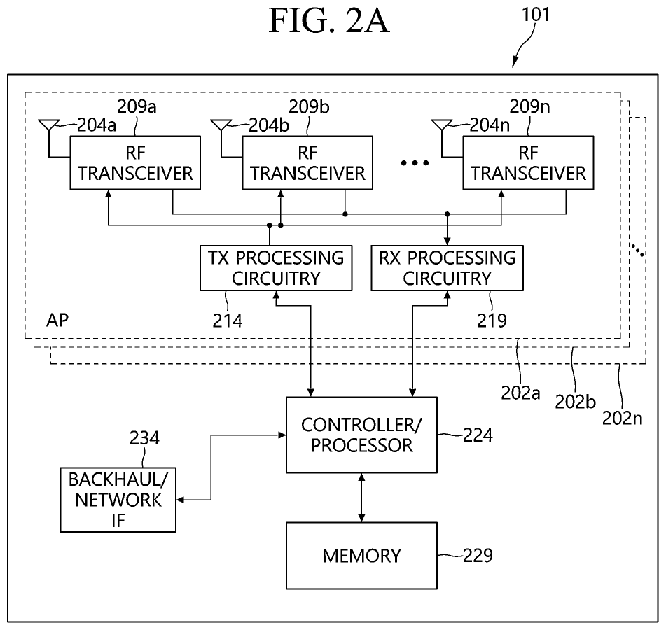

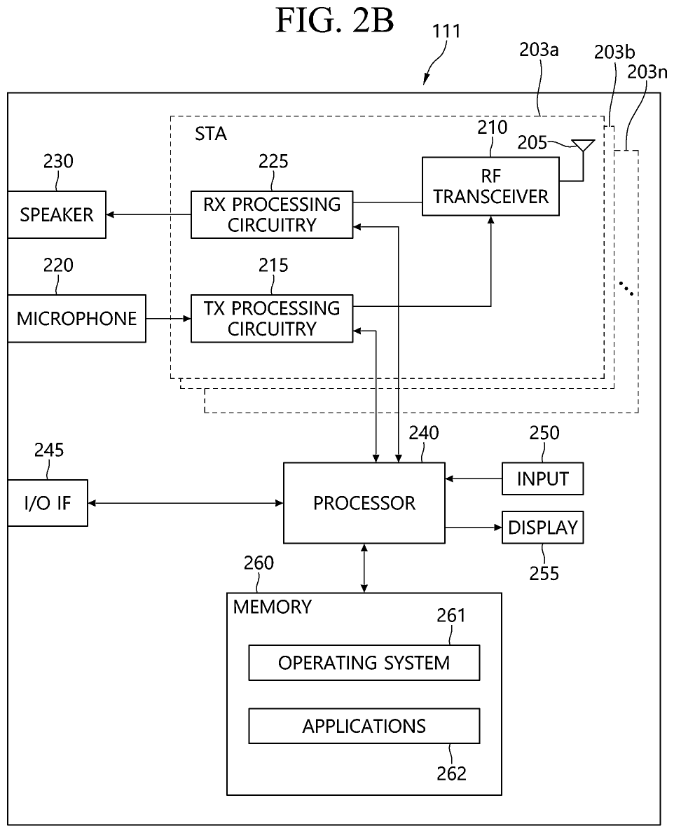

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

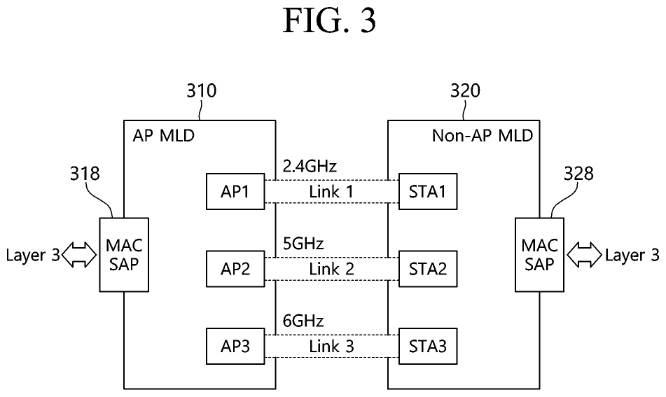

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: 1) IEEE 802.11-2020, “Wireless LAN Medium Access Control (MAC) and Physical Layer (PHY) Specifications;” 2) IEEE 802.11ax-2021, “Wireless LAN Medium Access Control (MAC) and Physical Layer (PHY) Specifications;” and 3) IEEE P802.11be/D5.0, “Wireless LAN Medium Access Control (MAC) and Physical Layer (PHY) Specifications”.

A wireless network station (STA) can be in one of two states, including an awake state and a doze state. In the awake state, the STA continuously monitors the channel and can transmit or receive packets. In the doze state, the STA does not monitor the channel, for example, for the purpose of saving power.

A non-AP STA can be in one of two power management modes, including an active mode and a power save (PS) mode. In the active mode, the STA receives and transmits frames at any time and the STA remains in the awake state. In the power save (PS) mode, the STA enters the awake state to receive or transmit frames and the STA remains in the doze state otherwise.

To allow non-AP STAs to save power, the existing standards support several power-save methods that determine how a STA behaves when in PS mode and how the STA transitions between power save mode and active mode. These include Normal power save (PS), automatic power save delivery (APSD), wireless network management (WNM) power save, Power-save multi-poll mode, Spatial multiplexing PS, Independent Basic Service Set (IBSS) power save, Very High Throughput (VHT) Transmission Opportunity (TXOP) Power Save, Target Wake Time (TWT), among others.

When operating in various power save modes, a STA may not be able to sense the wireless medium state or receive traffic. This can cause their Network Allocation Vector (NAV) to become outdated and the STA may not remain synchronized with the wireless medium, which may be referred to herein as a loss of medium synchronization. To prevent such a loss of medium synchronization from affecting other transmissions in the network, a medium synchronization recovery procedure has been defined by the standards which can be followed by a STA that has lost medium synchronization, after it is able to reliably sense the channel again. For example, after the transmission from the other STA of the Nonsimultaneous Transmit and Receive Operation (NSTR) pair has ended. In particular, the medium synchronization recovery procedure may involve the affected STA initializing a timer, which may be called a MediumSyncDelay timer, and pursuing a more conservative channel access procedure till the expiry of the timer, or recovery of medium synchronization, whichever occurs earlier. This conservative approach of initiating a transmit opportunity (TXOP) by the non-AP STA when its MediumSyncDelay>0, may involve: i) transmission of a request-to-send (RTS) as the first frame to gain TXOP; and ii) may not attempt more than MSD_TXOP_MAX TXOPs (default 1) and may use CCA_ED threshold equal to dot11MSDOFDMEDthreshold (default −72 dBm).

The conservative channel access procedure for a STA during MediumSyncDelay>0 can be inefficient and can be quite detrimental to its performance.

Many of the power saving features described above may not be applicable to access point (APs). To provide power saving mechanisms for APs (and also for STAs) that are operating in awake state, the IEEE 802.11-2020 standard defines a power saving mechanism called “operating mode change”. By using an operating mode change, a STA can change its operating channel width (CW) and/or the maximum number of spatial streams (NSS) that it can support. Thus, the STA can save power by reducing channel width or number of spatial streams when required. An AP or non-AP STA can change its RX operating mode by either: i) transmitting an Operating Mode Notification frame, which may be a Very High Throughput (VHT) Action frame (class 3 management), ii) transmitting an Operating Mode Notification element inside a beacon frame, (Re) association request or response frames, or iii) transmitting an Operating Mode (OM) Control subfield or EHT OM Control subfield in an A-control field of a Quality of service (QoS) Data, QoS Null or Class 3 Management frames. To indicate the different channel widths, modulation and coding schemes (MCS) and number of spatial streams (NSS) that a STA supports, each STA may also transmit a Capabilities element.

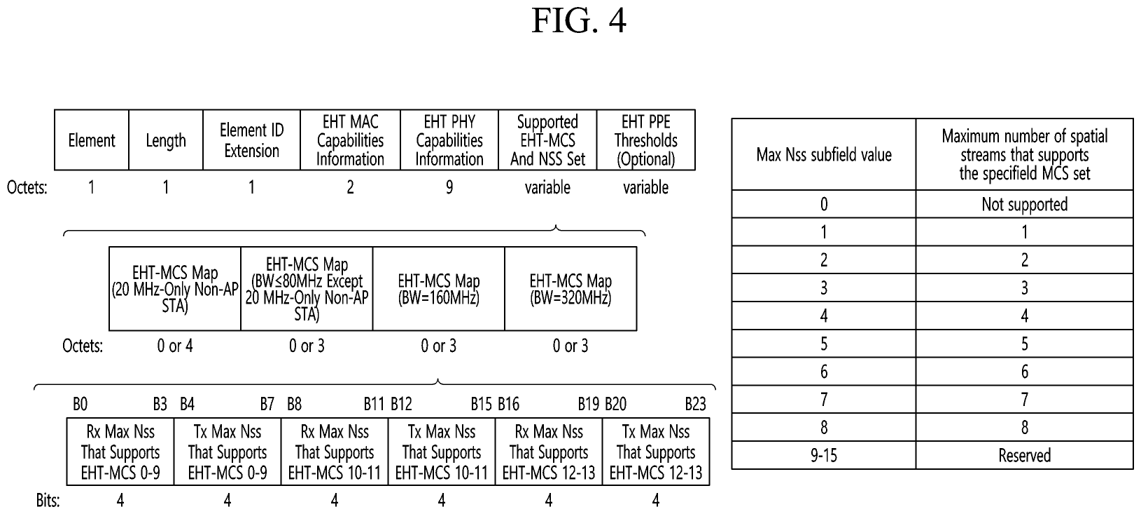

FIG. 4 illustrates an EHT Capabilities element in accordance with an embodiment. In the Supported Channel Width Set field of the Capabilities element, a STA indicates the different channel widths it supports. For an AP, this is a super set of the current BSS channel width indicated in Operations element(s). The MCS and NSS that can be supported at each CW is indicated in the Supported MCS and NSS Set field of the Capabilities element. The encoding is quite different for VHT, HE and EHT.

For HT, there is a 77-bit bitmap whose bit i is set to 1 if MCS i is supported. The values are common to all channel widths.

For VHT, the MCS that can be supported for each NSS is indicated in the range {0-7,0-8,0-9} in a 16-bit Supported MCS and NSS Set field. The values are common to all channel widths. Difference in the NSS Supported for each CW is identified from the ‘Supported Channel Width Set’ + ‘Extended NSS CW Support’ fields.

For HE, the MCS that can be supported for each NSS is indicated in the “Tx/Rx HE-MCS Map” subfields of the “Supported HE MCS and NSS Set” field of the HE capabilities element (similar to VHT). However, the Map is separate for each bandwidth range.

For EHT, the maximum NSS (for TX and RX respectively) for each MCS is indicated in the “EHT-MCS Map” subfield of the “Supported EHT MCS and NSS Set” field of the EHT capabilities element. Indication is separate for each MCS range {0-9,10-11,12-13} and is different for each Bandwidth.

The capabilities element is a “per link indication” and is transmitted by a non-AP STA according to the following: mandatorily carried in an Association or reassociation request frame sent by a non-AP STA; mandatorily present in a probe request frame sent by a non-AP STA; or mandatorily present in a TDLS Discovery Request/Response frame.

The capabilities element is a “per link indication” and is transmitted by AP STA according to the following: mandatorily carried in a beacon frame transmitted by the AP; mandatorily carried in an Association or reassociation response frame transmitted by the AP; or mandatorily carried in a probe response frame transmitted by the AP.

For improving channel access capability with limited hardware cost and power consumption or to improve spectral efficiency, IEEE 802.11be also supports an operating mode for a non-AP MLD device called enhanced multi-link single radio (EMLSR) mode. In EMLSR mode, a non-AP device behaves like a single radio device that can perform channel sensing and reception of elementary packets on multiple bands or links simultaneously (which may be referred to herein as EMLSR listen state), but can perform reliable data communication on only one link at a time. Thus, by opportunistically selecting a link for data-communication where it wins the channel contention, EMLSR can improve system spectral efficiency.

In discussions for the IEEE 802.11bn, attention has been paid towards the need to reduce the power consumption at the AP side. For this, several strategies have been discussed including scheduling periodic sleep durations for the AP, enabling cross-link AP wakeup request, enabling dynamic power saving for the AP by use of EMLSR “listen” operation, among others.

In some embodiments, in order to save power and yet minimize the degradation in performance for latency sensitive traffic, an AP may operate in Dynamic Power Save (DPS) mode. In DPS mode, by default, the AP may operate with reduced capabilities, e.g., one or more of reduced channel width, support for limited Physical Protocol Data Unit (PPDU) formats, a reduced MCS set and NSS set, among other capabilities. The AP may operate with reduced capabilities for reception, for transmission, or for both. Operating with reduced capabilities may enable the AP to save power. Without loss of generality, the reduced channel width, limited PPDU formats, MCS set and NSS values may be referred to herein as reduced operating parameters. The AP may indicate reduced operating parameters applied during DPS mode operation. A STA may receive this indication from the AP and communicate with the AP in accordance with the AP's indicated reduced capabilities. However, upon receiving a request within a TXOP, the AP can increase one or more of its operating parameters, including supported bandwidth (BW), supported PPDU formats, MCS set and NSS set for at least the duration of the TXOP. Without loss of generality, this channel width and MCS and NSS values may be referred to herein as the enhanced operating parameters. Thus, after sending a request to the AP to increase the capabilities of an AP, the TXOP owner can perform communication at the enhanced operating parameters, including enhanced channel width, PPDU formats, MCS and NSS values for the rest of the TXOP. After the end of the TXOP or after a predetermined amount of time from the end of the TXOP, the AP may return to its reduced operating parameters. In some embodiments, a STA that is the owner of TXOP or one monitoring the request and response during TXOP, may assume the AP will continue to remain in the enhanced operating status for at least the pre-determined amount of time. When operating in DPS mode, the AP may need a time of DPS Padding Delay to transition from reduced operating parameters to enhanced operating parameters, and a time of DPS Transition Delay for the reverse transition. These parameters can be indicated by the AP in its UHR capabilities element.

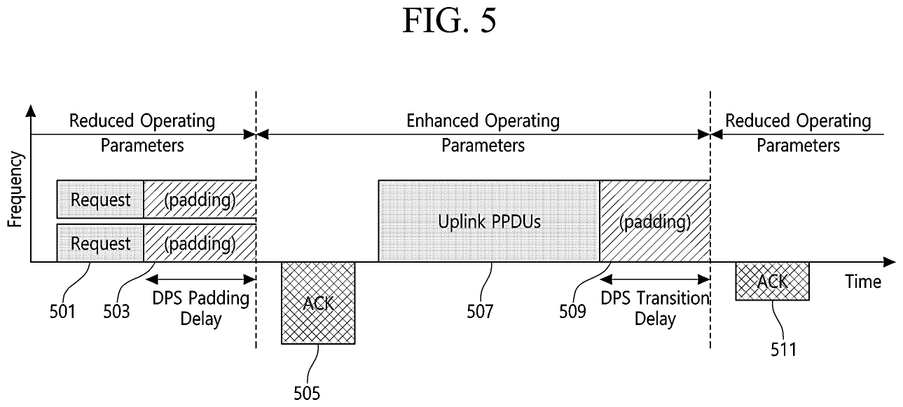

FIG. 5 illustrates an example of an uplink frame exchange by a STA with an AP operating in DPS mode in accordance with an embodiment. In particular, FIG. 5 illustrates an uplink frame exchange between a STA and an AP operating in DPS mode, wherein the STA requests the AP to transition to enhanced capabilities. As illustrated, the STA may transmit a request frame 501. The request frame 501 may include padding 503 for a DPS Padding Delay for a time that the AP may need to transition from reduced operating parameters to enhanced operating parameters. The AP may transmit an acknowledgement (ACK) frame 505, and the AP transitions to operating with the enhanced operating parameters. During the time at which the AP is operating with the enhanced operating parameters, the STA may transmit uplink PPDUs 507 and a padding 509 for a DPS Transition Delay for the AP to transition from the enhanced operating parameters to the reduced operating parameters. After the padding 509, the AP transitions to the reduced operating parameters and transmits an ACK frame 509 to the STA.

The DPS mode can also be considered as an extension of EMLSR operation for an AP or an extension of enhanced multi-link multi-radio (EMLMR) operation for an AP and can reuse some of the same notification frames.

Dynamic Power Saving (DPS) offers a mechanism for an AP to save power which does not degrade the performance of latency sensitive traffic and can also maintain compatibility with legacy devices. When operating in DPS mode, an AP may frequently transition between the reduced operating parameters state and the enhanced operating parameters state and vice-versa. During such transitions, the AP may not be able to sense the wireless medium state or receive traffic. This “blindness” issue can persist for the DPS Padding Delay duration when switching from reduced to enhanced operating parameters, and for the DPS Transition Delay duration when switching from the enhanced to reduced operating parameters. When such a transition happens, it can cause the APs Network Allocation Vector (NAV) to become outdated and can cause loss of medium synchronization at the AP. The conservative channel access procedure during loss of medium synchronization can be detrimental to the performance of the AP's basic service set (BSS).

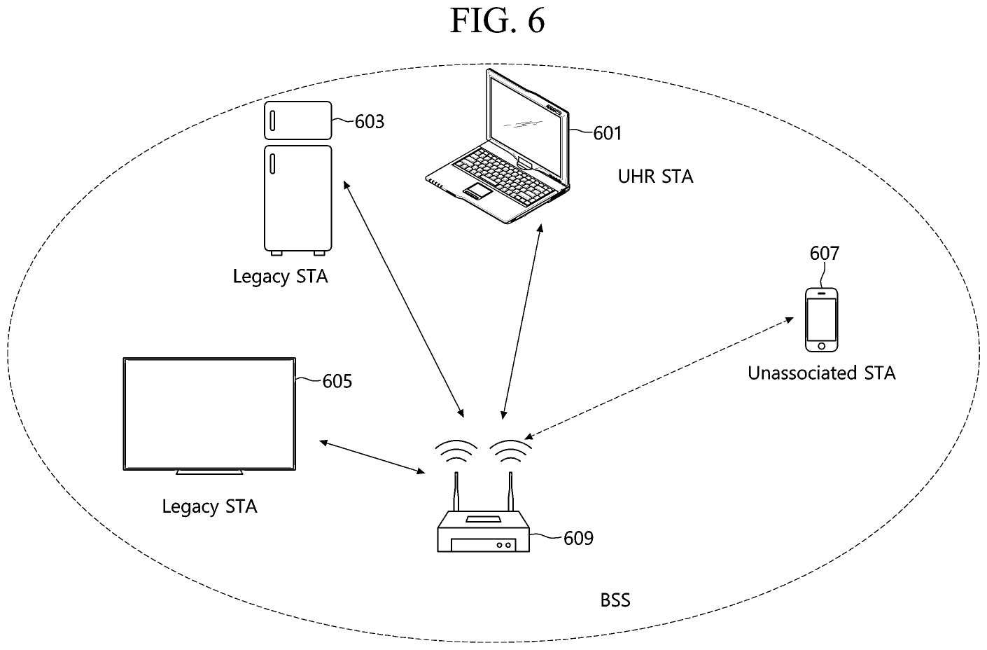

FIG. 6 illustrates a generic scenario whereby an AP operates a Basic Service Set (BSS) with several associated STAs in accordance with an embodiment. As illustrated, some of the STAs may be UHR STAs 601, and some may be legacy STAs 603 and 605. There may also be several unassociated STAs 607 which may intend to associate with the AP 609 later. Based on implementation specific reasons, the AP 609 may intend to reduce its operating parameters (such as channel width, number of spatial streams, physical protocol data unit format capability, among others) with the intent of saving power. However, while doing so, the AP may also intend to limit degradation in performance for UHR STAs 601 by being able to perform dynamic expansion of its operating parameters. As described herein, the terms “channel width” and “bandwidth” may be used interchangeably. For doing this, the AP may decide to operate to Dynamic Power Save (DPS) mode. The mechanism for the AP to indicate the parameters of DPS operation and the procedure for the AP to indicate transition into DPS mode is outside the scope of this disclosure.

Transmission parameters for downlink and uplink transmissions in accordance with this disclosure is described herein. In some embodiments, for downlink transmissions when operating in DPS mode, the AP may use transmission parameters (e.g., bandwidth, NSS, MCS, among others) that comply with the AP's reduced operating parameters, and the capabilities of the receiving STA. In some embodiments, for downlink transmissions when operating in DPS mode, the AP may internally decide whether it wants to operate with the enhanced operating parameters or the reduced operating parameters, which may be referred to herein as current operating parameters. Accordingly, upon winning a transmit opportunity, the AP may transmit frames with the transmissions complying with the current AP operating parameters and the capabilities of the receiving STA. In certain embodiments, the AP may use transmission parameters (bandwidth, NSS, MCS etc.) that comply with the AP's reduced operating parameters, and the capabilities of the receiving STA when the receiving STA is before a specific WiFi generation (e.g., pre-IEEE 802.11bn) STA. In some embodiments, the AP may internally decide whether it wants to operate with the enhanced operating parameters or the reduced operating parameters, and upon winning a transmit opportunity it may transmit frames with the transmissions complying with the current AP operating parameters and the capabilities of the receiving STA if the STA is after a specific WiFi generation (e.g. IEEE 802.11bn).

In some embodiments, for uplink transmissions and triggered uplink transmissions, by default a STA may use transmission parameters that comply with the AP's reduced operating parameters. If the STA supports DPS operation and intends to use the enhanced operating parameters for transmission for the rest of the frame exchange, the STA may transmit a request frame to the AP to request the transition to enhanced capabilities. All subsequent frames exchanged in the transmit opportunity (TXOP) can then be sent with compliance to the enhanced operating parameters of the AP. A request frame may be referred to herein as a DPS Wakeup Request frame and the request frame can be sent in the beginning of a TXOP or anytime in the middle of a TXOP.

In some embodiments, if the STA is aware that the AP is currently operating with the enhanced operating parameters using other indications, the STA may directly transmit frames with parameters that comply with the AP's enhanced operating parameters (without needing to send a request frame).

In some embodiments, a non-AP STA can indicate if it is capable of sending a request frame to an AP operating in DPS to transition to the enhanced capabilities, by setting a capability bit to 1 in the UHR Capabilities element that the STA transmits in probe request and association response frames. Otherwise, the bit may be set to 0. The bit can be, for example, called the DPS Support subfield. In some embodiments, a non-AP STA may use a separate bit to indicate that it is capable of supporting protection of medium for an AP transitioning between DPS states, by setting a capability bit to 1 in the UHR Capabilities element that it transmits in probe request and association response frames. The bit can be, for example, the DPS Medium Protection Support subfield.

As described herein, DPS operation may require frequent transition of an AP's state between the enhanced operating parameters state and reduced operating parameters state, and such transitions can potentially cause loss of medium synchronization at the AP and packet failures, if not dealt with appropriately. Embodiments in accordance with this disclosure provide several solutions to address this issue and are discussed herein. As described herein, a TXOP owner or a TXOP initiator may be the device that has obtained the right to transmit on the wireless medium via the channel contention process. A TXOP responder may be a device to which a frame transmitted by a TXOP owner in a TXOP is addressed to.

As described herein, the term padding may be used loosely and can refer to either a padding field, or any frame or element, that is included within a transmission and is not expected to be decoded by the receiver. This can include, for example, the padding field of trigger frames, packet extension field, a QoS frame with garbage bits, among other fields. In some embodiments, a new Padding element may be defined, which carries padding bits. The element can include one or more of: an Element ID field, a Length field, a Time Duration field for indicating the duration of the element, and a padding field. In some embodiments, the Padding element can be included by a transmitter within a frame to provide the necessary padding.

Ensuring medium synchronization during DPS state transition as neither TXOP owner nor responder in accordance with this disclosure is described herein. In some embodiments, it may be assumed that the AP is neither the TXOP owner nor TXOP responder. During the transition from the reduced operating parameters state to the enhanced operating parameters state or vice versa, the AP may not be able to sense the medium state or receive traffic. When such a transition happens, it can cause loss of medium synchronization at the AP.

In some embodiments, where the AP is initially in a reduced parameters state and intends to transition to an enhanced parameters state, if the AP is able to detect the preamble of a frame that is not addressed to it and for which the Network Allocation Vector (NAV) time is longer than the DPS Padding Delay, the AP may perform the transition during the duration of that TXOP. In some embodiments, it may be sufficient for this detected frame to overlap with the primary 20 MHz channel of the AP's BSS.

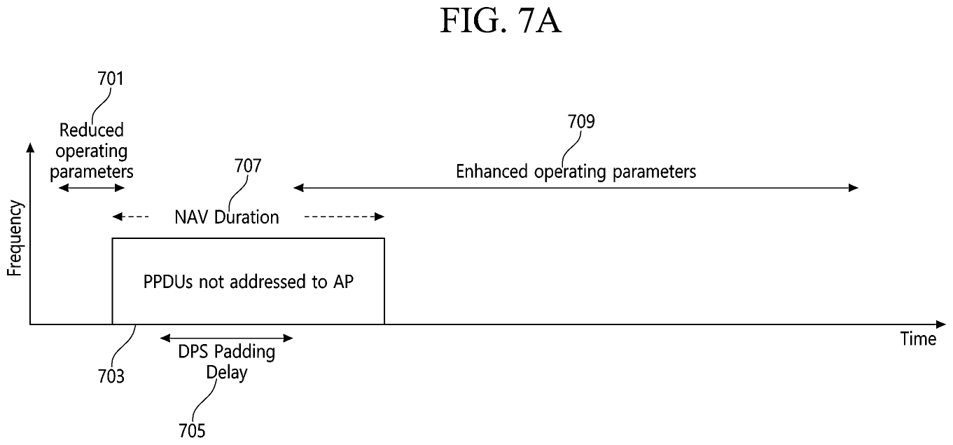

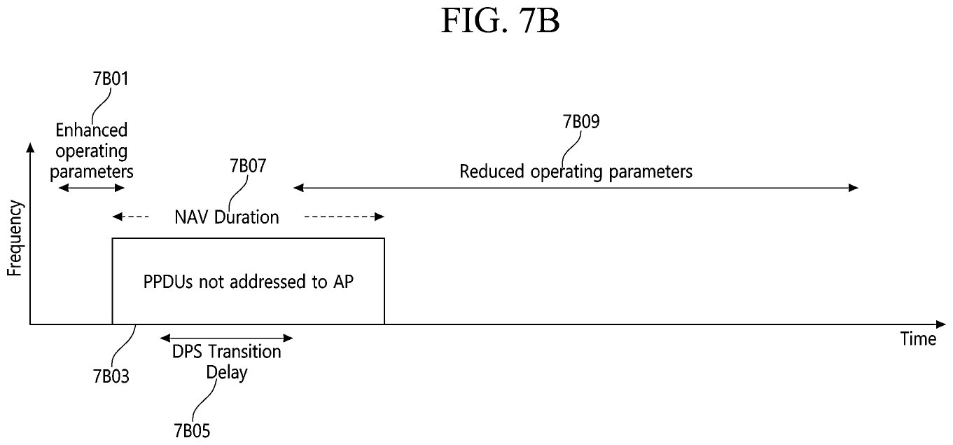

FIG. 7A illustrates the use of a TXOP not addressed to the AP for performing the transition from reduced operating parameters to enhanced operating parameters in accordance with an embodiment. As illustrated, the AP initially operates with reduced operating parameters 701, and detects the preamble of PPDUs 703 that are not addressed to the AP. The PPDUs include a NAV duration 707 that is longer than the DPS Padding Delay 705, and thus provide the DPS Padding Delay 705 for a time that the AP may need to transition from reduced operating parameters 701 to enhanced operating parameters 709. Accordingly, the AP transitions from the reduced operating parameters 701 to the enhanced operating parameters 707 after the DPS padding delay 705.

In some embodiments, the decision to use a PPDU (or the corresponding TXOP) to perform DPS state transition can be based on, one or more of: i) the physical layer (PHY) version format of the PPDU (non-HT/HT/VHT/HE/EHT/UHR, among others); ii) the duration of the PPDU (for example, as indicated in the L-SIG field); iii) the NAV set by the PPDU (for example, as indicated either in the PHY header for HE+ format, or MAC header); iv) the BSS Color of the PPDU; v) the TA and RA of the PPDU; or vi) the DPS Padding Delay value.

In some embodiments, after detecting a PPDU, the AP may perform the transition if the remaining PPDU duration (e.g., after determining that the frame is either in error or is not addressed to the STA) is greater than the DPS Padding Delay. For any frame, after receiving the RA and TA of the MAC header, the recipient STA can determine that a PPDU is either in error, or is not addressed to it. If the frame is in HE format or beyond and from another BSS, then the recipient STA can make a determination regarding whether the PPDU is in error or not addressed to the STA at an earlier time based on the BSS Color in the PHY header.

In some embodiments, after detecting a PPDU, the AP may perform the transition if the remaining TXOP duration, after validating the NAV, is greater than the DPS Padding Delay. For any frame, after performing an FCS check, the recipient STA can determine that the NAV information is valid. If the frame is in HE format or beyond, then the recipient STA can determine this a bit earlier based on the TXOP subfield in the PHY header.

In some embodiments where the AP is initially in the enhanced parameters state and intends to transition to the reduced parameters state, if the AP is able to detect the preamble of a frame that is not addressed to it and for which the Network Allocation Vector (NAV) time is longer than the DPS Transition Delay, the AP may perform the transition during the duration of that TXOP. In some embodiments, it may be sufficient for a detected frame to overlap with the primary 20 MHz channel of the AP's BSS.

FIG. 7B illustrates use of a TXOP not addressed to the AP for performing the transition from enhanced operating parameters to reduced operating parameters in accordance with an embodiment. As illustrated, the AP initially operates with enhanced operating parameters 7B01, and detects the preamble of PPDUs 7B03 that are not addressed to the AP. The PPDUs include a NAV duration 7B07 that is longer than the DPS Transition Delay 7B05, and thus provide the DPS Transition Delay 7B05 for a time that the AP may need to transition from enhanced operating parameters 7B01 to reduced operating parameters 7B09. Accordingly, the AP transitions from the enhanced operating parameters 7B01 to the reduced operating parameters 7B09 after the DPS Transition Delay 7B05.

In some embodiments, the decision to use a PPDU (or the corresponding TXOP) to perform DPS state transition can be based on, one or more of: i) the PHY version format of the PPDU (non-HT/HT/VHT/HE/EHT/UHR, among others); ii) the duration of the PPDU (for example, as indicated in the L-SIG field); iii) the NAV set by the PPDU (for example, as indicated either in the PHY header for HE+ format, or MAC header); iv) the BSS Color of the PPDU; v) the TA and RA of the PPDU; or vi) the DPS Transition Delay value.

In some embodiments, after detecting a PPDU, the AP may perform the transition if the remaining PPDU duration, after determining that the frame is either in error or is not addressed to the STA, is greater than the DPS Transition Delay. For any frame, after receiving the receiver address (RA) and transmitter address (TA) of the Media Access Control (MAC) header, the recipient STA can determine that a PPDU is either in error, or is not addressed to it. If the frame is in High Efficiency (HE) format or beyond and from another BSS, then the recipient STA can determine this a bit earlier based on the BSS Color in the PHY header.

In some embodiments, after detecting a PPDU, the AP may perform the transition if the remaining TXOP duration (after validating the NAV) is greater than the DPS Transition Delay. For any frame, after performing a frame check sequence (FCS) check, the recipient STA can determine that the NAV information is valid. If the frame is in High Efficiency (HE) format or beyond, then the recipient STA can determine this a bit earlier based on the TXOP subfield in the PHY header.

In some embodiments, the preamble of the PPDU may need to satisfy some additional constraints for the AP to be able to use it to perform the transition. Such constraints can be based on, for example, the BSS Color of the PPDU, signal power of the detected preamble, the format of the detected PPDU, the PPDU duration, the spatial reuse flag of the PPDU, among others. In some embodiments, constraints can be: i) the BSS color of the preamble detected by the AP does not match the AP's BSS; ii) the BSS color of the preamble detected by the AP matches the AP's BSS; iii) the measured signal power of the preamble of the PPDU is higher than a given threshold, (e.g., −62 dBm or −72 dBm); v) the format of the first PPDU sent in this TXOP can be the non-HT format; or vi) the preamble of the PPDU can prevent the use of spatial reuse over the TXOP. In some embodiments, a combination of the above type of constraints may be applicable to determine if a PPDU (or its corresponding TXOP) can be used for performing the transition. In some embodiments, the AP may not use such a TXOP for performing state transition if one or more of the following are satisfied: 1) the AP allows non-primary channel access (NPCA) mechanism in its BSS, 2) the TXOP is eligible for NPCA and 3) the NPCA switching delay is not sufficient for the AP to perform the state transition and also perform the channel switch to the non-primary channel.

In some embodiments, an AP operating in DPS mode may also disable the use of spatial reuse mechanisms in its BSS. In some embodiments, the AP operating in DPS mode may not support or participate in all or some of the multi-AP coordination mechanisms. In some embodiments, the AP operating in DPS mode may disallow NPCA use in its BSS.

Ensuring medium synchronization during a DPS state transition as a TXOP owner in accordance with this disclosure is described herein. In some embodiments described below, it may be assumed that the AP is the TXOP owner. During the transition from the reduced operating parameters state to the enhanced operating parameters state or vice versa, the AP may not be able to sense the medium state or receive traffic. When such a transition happens as a TXOP owner, it can cause loss of medium synchronization at the AP and can also cause collisions with frames transmitted by other STAs.

In some embodiments, the AP may not perform a DPS state transition as a TXOP owner.

In some embodiments, it may be ensured that during the transition, the AP is capable of performing listening operation to prevent loss of medium synchronization.

In some embodiments, it may be ensured that that the DPS Padding Delay and/or the DPS Transition Delay for an AP are shorter than a predetermined threshold interval. This interval can be, for example, the DIFS interval or SIFS interval.

In some embodiments, where the AP is initially in reduced parameters state and intends to transition to enhanced parameters state, upon winning a TXOP, the AP may transmit a CTS-to-self frame in non-HT format to set the Network Allocation Vector (NAV) for a duration of at least a DPS Padding Delay beyond the end of the CTS-to-self frame and may then transition to the enhanced operating parameters during this time. This procedure may prevent associated STAs which can hear the AP from initiating transmission to the AP during the transition, thus preventing loss of frames.

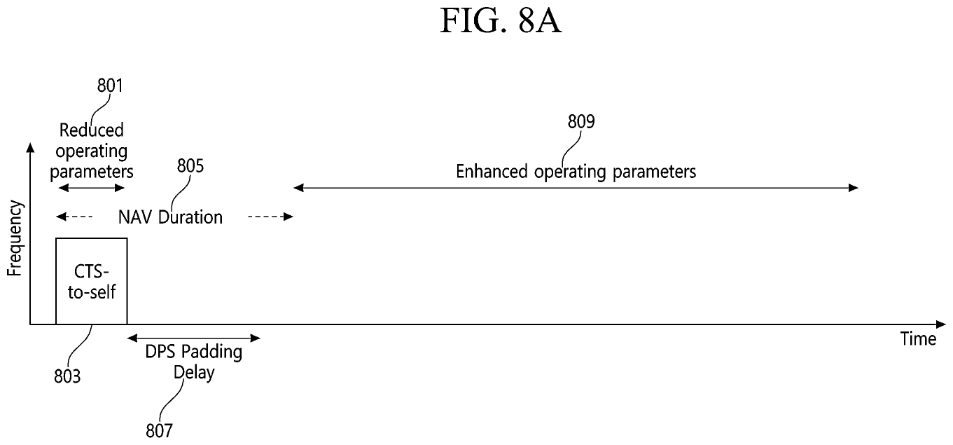

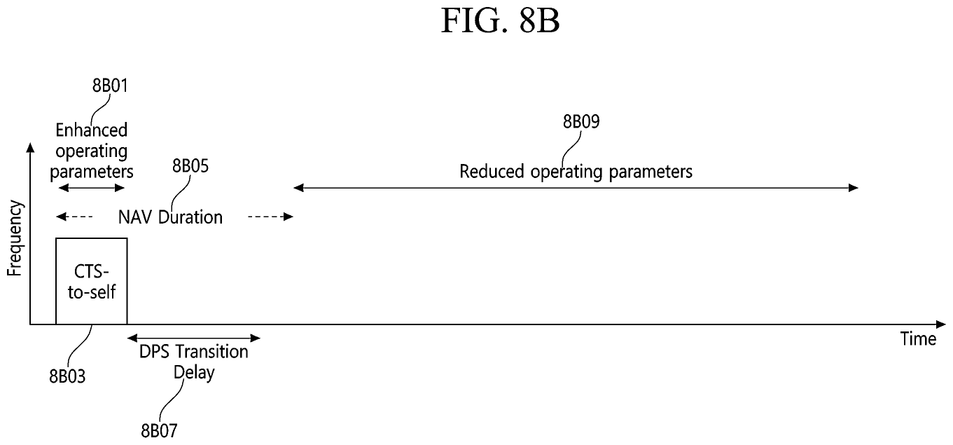

FIG. 8A illustrates protection of the medium for the transition from reduced to enhanced operating parameters as a TXOP owner using CTS-to-self in accordance with an embodiment. As illustrated, the AP is initially in reduced operating parameters state 801 and intends to transition to enhanced operating parameters state 809. Upon winning a TXOP, the AP transmits a CTS-to-self frame 803 in non-HT format to set the NAV duration 805 for a duration of at least a DPS Padding Delay 807 beyond the end of the CTS-to-self frame 803. Accordingly, the AP transitions to the enhanced operating parameters 809.

In some embodiments, instead of a CTS-to-self frame, a new frame may be defined for setting the NAV for the transition. This new frame may be referred to herein as, for example, an Unavailability Indication frame and may include an indication of the time of unavailability of the AP. In some embodiments, the time may be the same or different from the NAV time of the frame. The Unavailability Indication frame may also include a Reason Code for the unavailability, and/or an indication of the capabilities of the AP during the unavailability period. Note that although this procedure is shown as the first operation of the TXOP in FIG. 8A, this may even be performed in the middle or end of the TXOP after completing some frame exchanges. In some embodiments, the Unavailability indication can be carried in a frame as a new element, or a new field, such as, an Unavailability Indication A-control field among others.

In some embodiments, where the AP is initially in the enhanced parameters state and intends to transition to the reduced parameters state, upon winning a TXOP the AP may transmit a CTS-to-self frame in non-HT format on the primary 20 MHz channel, to set the Network Allocation Vector (NAV) for a duration of at least a DPS Transition Delay beyond the end of the CTS-to-self frame. The AP may then transition to the reduced operating parameters during this time. This procedure may prevent associated STAs which can hear the AP from initiating transmission to the AP during the transition, thus preventing loss of frames.

FIG. 8B illustrates protection of the medium for the transition from enhanced to reduced operating parameters as a TXOP owner using CTS-to-self in accordance with an embodiment. As illustrated, the AP is initially in enhanced operating parameters state 8B01 and intends to transition to reduced operating parameters state 8B09. Upon winning a TXOP, the AP transmits a CTS-to-self frame 8B03 in non-HT format to set the NAV duration 8B05 for a duration of at least a DPS Transition Delay 8B07 beyond the end of the CTS-to-self frame 8B03. Accordingly, the AP transitions to the reduced operating parameters 8B09.

In some embodiments, instead of a CTS-to-self frame, a new frame may be defined for setting the NAV for the transition. This new frame may be referred to herein as, for example, Unavailability Indication frame and may include an indication of the time of unavailability of the AP (can be same or different from the NAV time of the frame), a Reason Code for the unavailability, and/or an indication of the capabilities of the AP during the unavailability period. Note that although this procedure is shown as the first operation of the TXOP in FIG. 8B, this may even be performed in the middle or end of the TXOP after completing some frame exchanges. In some embodiments, the Unavailability indication can be carried in a frame as a new element, or a new field, such as, an Unavailability Indication A-control field among others.

In some embodiments, where the AP is initially in the reduced parameters state and intends to transition to the enhanced parameters state, upon winning a TXOP, the AP may first transmit a frame to a non-AP STA that supports DPS operation with an indication that the AP intends to transition from reduced to enhanced operating parameters. The transmitted frame may include an indication of one or more of: i) an indication that the AP is soliciting padding in response frame; ii) an identifier of the non-AP STA from whom padding is solicited; iii) an indication of the reason for the padding; iv) the required duration of the padding; v) the current DPS state of the AP; vi) the new DPS state of the AP; or vii) required transmission bandwidth of the response frame.

In some embodiments, in the response frame, the non-AP STA can include sufficient padding to protect the medium till the AP performs the transition to the enhanced operating parameters (DSP Padding Delay). The term padding as described herein may include any bits included by the STA that are not expected to be decoded by the AP.

In some embodiments, the frame can be a trigger frame, such as the Buffer Status Report Poll (BSRP) frame or the Basic Trigger frame. The trigger frame may have new fields, within either the Common Info field or Special User Info field among other fields, to indicate that the AP is soliciting padding in the response frame to support DPS state transition. The AP can use the UL Length field to indicate the duration of the required padding. The trigger frame may occupy bandwidth up to the reduced operating channel width of the AP. The non-AP STA in the response frame to the trigger frame may include sufficient padding to protect the channel till the AP performs the transition to enhanced operating parameters (DPS Padding Delay).

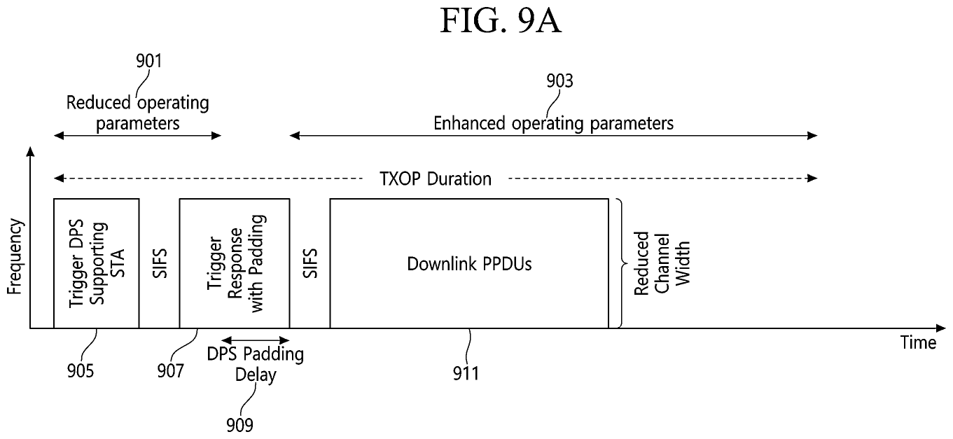

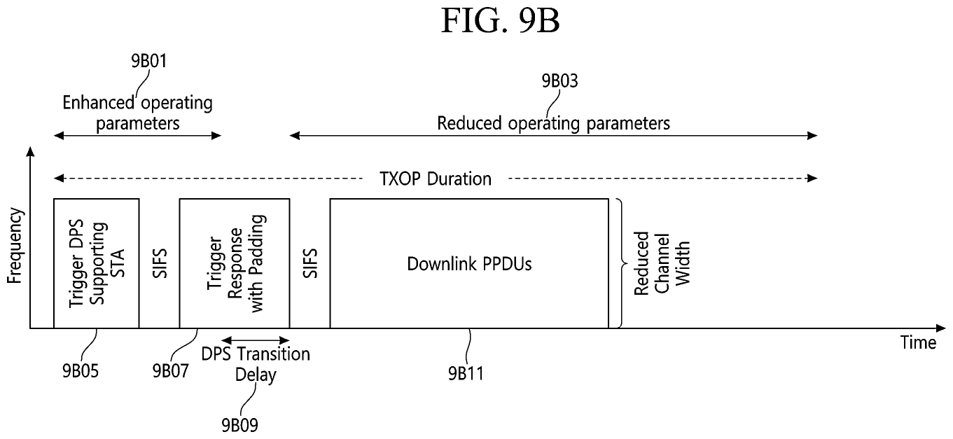

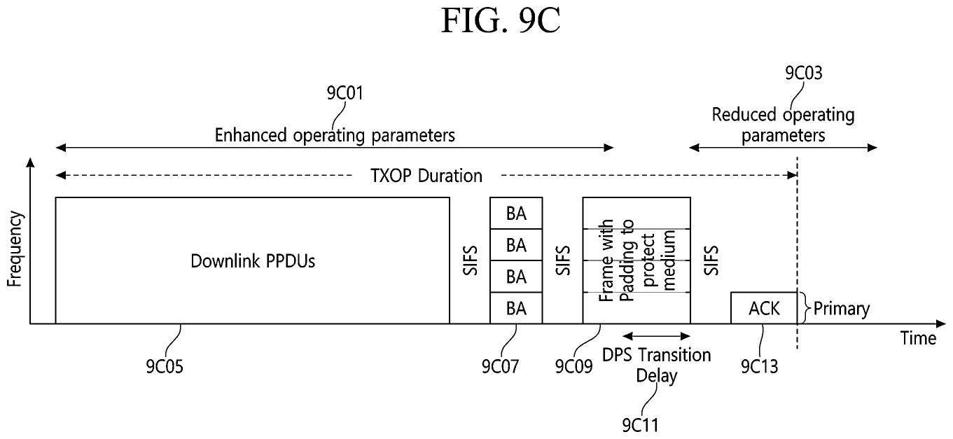

FIG. 9A illustrates protection of the medium for the transition from reduced to enhanced operating parameters in a downlink TXOP using assistance from a STA in accordance with an embodiment. Note that although this procedure is shown as the first operation of the TXOP here, this procedure may even be performed in the middle or end of the TXOP after completing some frame exchanges. In some embodiments, the frame exchanges after the transition within the TXOP may be restricted to the TXOP bandwidth of the trigger frame. As illustrated, the AP is initially in the reduced parameters state 901 and intends to transition to the enhanced parameters state 903, upon winning a TXOP, the AP may first transmit a trigger frame 905 to a non-AP STA that supports DPS operation with an indication that the AP intends to transition from reduced to enhanced operating parameters. After an SIFS, the AP receives a trigger response with padding 907 that provides the DPS Padding Delay 909 to protect the channel till the AP performs the transition to the enhanced operating parameters 903. During the time the AP operates with the enhanced operating parameters 903, the AP transmits downlink PPDUs 911.

In some embodiments, where the AP is initially in the enhanced parameters state and intends to transition to the reduced parameters state, upon winning a TXOP, the AP may first transmit a frame to a non-AP STA that supports DPS operation with an indication that the AP intends to transition from enhanced to reduced operating parameters. The transmitted frame may include an indication of one or more of: i) an indication that the AP is soliciting padding in response frame; ii) an identifier of the non-AP STA from whom padding is solicited; iii) an indication of the reason for the padding; iv) the required duration of the padding; v) the current DPS state of the AP; vi) the new DPS state of the AP; or vii) required transmission bandwidth of the response frame.

In some embodiments, in the response frame, the non-AP STA can include sufficient padding to protect the medium till the AP performs the transition to the reduced operating parameters (DSP Transition Delay).

In some embodiments, the frame can be a trigger frame, such as, the Buffer Status Report Poll (BSRP) frame or the Basic Trigger frame. The trigger frame may have new fields, within either the Common Info field or Special User Info field, to indicate that the AP is soliciting padding in the response frame to support DPS state transition. The AP can use the UL Length field to indicate the duration of the required padding. In some embodiments, the trigger frame may occupy bandwidth up to the reduced operating channel width of the AP. The non-AP STA in the response frame to the trigger frame may include sufficient padding to protect the channel till the AP performs the transition to reduced operating parameters (DPS Transition Delay).

FIG. 9B illustrates protection of the medium for the transition from enhanced to reduced operating parameters in a downlink TXOP using assistance from a STA in accordance with an embodiment. Note that although this procedure is shown as the first operation of the TXOP here, this may even be performed in the middle or end of the TXOP after completing some frame exchanges. In some embodiments, the frame exchanges after the transition within the TXOP may be restricted to the smaller of the TXOP bandwidth, and the reduced capability bandwidth of the AP. As illustrated, the AP is initially in the enhanced operating parameters state 9B01 and intends to transition to the reduced operating parameters state 9B03, upon winning a TXOP, the AP may first transmit a trigger frame 9B05 to a non-AP STA that supports DPS operation with an indication that the AP intends to transition from enhanced to reduced operating parameters. After an SIFS, the AP receives a trigger response with padding 9B07 that provides the DPS Transition Delay 9B09 to protect the channel till the AP performs the transition to the reduced operating parameters 9B03. During the time the AP operates with the reduced operating parameters 9B03, the AP transmits downlink PPDUs 9B11.

In some embodiments, if a DPS capable STA expects the AP to perform a transition from reduced operating parameters to enhanced operating parameters or vice versa during a TXOP, the STA may automatically send a frame to the AP with sufficient padding to enable the switch without the AP having to send an explicit trigger frame. In some embodiments, a new frame can be defined, that can carry padding and can be transmitted by a TXOP responder. In some embodiments, the frame may be transmitted on the full bandwidth of the TXOP.

FIG. 9C illustrates the protection of medium for transition from enhanced to reduced operating parameters after downlink transmission using an un-triggered transmission by a non-AP STA in accordance with an embodiment. As illustrated, the AP initially operates with enhanced operating parameters 9C01. During the TXOP, the AP transmits downlink PPDUs 9C05, after an SIFS, receives BA 9C07. After SIFS, the AP receives a frame 9C09 with padding to protect the medium, and which padding enables the AP to switch, during the DPS Transition Delay 9C11, without the AP having to send an explicit trigger frame. Accordingly, after the DPS transition delay 9C11, the AP transitions to operating with the reduced operating parameters 9C03, during which the AP transmits ACK frame 9C13 on a primary 20 MHz bandwidth.

In some embodiments, a frame may be transmitted on the primary 20 MHz bandwidth. After the transition, the AP may transmit an acknowledgement (ACK) frame for the new frame on the smaller of: (i) the TXOP bandwidth and (ii) the AP's current operating bandwidth, or the ACK can be sent on the primary 20 MHz channel. In certain embodiments, the frame may not solicit an ACK response. Such a frame can be, for example, a new variant of an ACK frame or block acknowledgement (BA) frame. Note that although this procedure is shown as the last operation of the TXOP in FIG. 9C, this may even be performed in the middle of the TXOP after completing some frame exchanges or at the beginning of the TXOP.

In some embodiments, the AP may indicate within the TXOP its intention to transition to reduced or enhanced operating parameters at the end of the TXOP. In certain embodiments, the AP may also indicate one or more STAs that the AP requests to assist with protecting the medium while the AP transitions from the enhanced operating parameters to the reduced operating parameters or vice versa. These STAs may be among the STAs that have indicated support for DPS operation. When the AP is the TXOP owner, such indications can be included, for example, within a trigger frame transmitted by the AP or an A-control field of a frame sent by the AP.

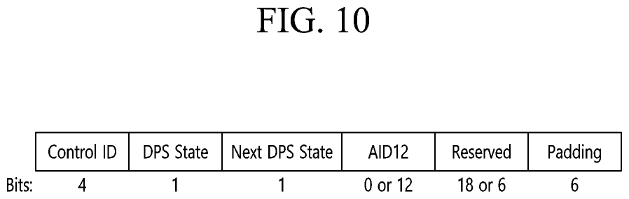

FIG. 10 illustrates an indication by the AP in DPS mode of its intention to transition to another DPS state in an A-control field in accordance with an embodiment. The A-Control field may include a control ID field, a DPS state field, a next DPS state field, a AID12 field, a reserved field and a padding field. The control ID field may provide control identifier information. The DPS State field may indicate the current DPS state of the AP and can be set to 1 to indicate enhanced operating parameters and 0 to indicate reduced operating parameters. The Next DPS State field may indicate the next DPS state of the AP after the TXOP including the transmission of the A-control. In some embodiments, if the DPS State and Next DPS State fields are different, then an AID12 subfield may be present in the A-control field. Here the STA from which assistance is solicited can be identified by the 12 least-significant bits of its association ID indicated in the AID12 subfield. In some embodiments, where the A-control is sent in an individually addressed frame, the STA to which the frame is addressed (as indicated in the MAC header) may be the STA from which the AP is soliciting the assistance for the transition. The reserved field may be reserved. In some embodiments, the current DPS state and next DPS state fields may not be present, assuming that the recipient is aware of the current DPS state, and the A-control field is only included when a DPS state transition is requested.

In some embodiments, a new element or field may be defined which can be included by an AP in a frame to indicate to one or more recipient non-AP STAs that the AP is soliciting padding to transition in its DPS state in the following TXOP. In the first TXOP initiated by any of the addressed STAs after the indication, the STA may include the necessary padding to help the AP transition its DPS state. Note that here the state transition may happen in a different TXOP than the one where the indication was provided by the AP.

Note that although the above procedures have been mentioned for the case where the AP is a TXOP initiator, all, or some of them also may be applicable for the case where the AP is the TXOP responder. They may also be applicable for the case where the AP is not the TXOP owner, but the TXOP has been shared with the AP via triggered TXOP sharing procedure.

Ensuring medium synchronization during DPS transition as a TXOP responder in accordance with this disclosure is described herein. In some embodiments, it may be assumed that the AP is the TXOP responder. During the transition from the reduced operating parameters state to the enhanced operating parameters state or vice versa, the AP may not be able to sense the medium state or receive traffic. When such a transition happens as a TXOP responder, it can cause loss of medium synchronization at the AP and can also cause failure of transmissions initiated by other STAs addressed to the AP.

In some embodiments, the AP may not perform one or both of the DPS state transitions (enhanced to reduced or reduced to enhanced) as a TXOP responder.

In some embodiments, it can be ensured that during the transition from enhanced operating parameters to reduced operating parameters, the AP is capable of performing listening operation to prevent loss of medium synchronization.

In some embodiments, it may be ensured that that the DPS Padding Delay and/or the DPS Transition Delay for an AP are shorter than a predetermined threshold interval. This interval can be, for example, the SIFS or DIFS interval. In some embodiments, if the delay is shorter than the DIFS interval, the transition may be performed at the end of the TXOP after sending an acknowledgement frame.

In some embodiments, when a non-AP STA (that supports DPS operation) initiates a transmission with an AP operating in DPS mode and the AP is expected to transition from enhanced capabilities to reduced capabilities at the end of the transmission, then the non-AP STA can end its transmission such that there is sufficient time for the AP to transmit an acknowledgement for the transmission (if required) and also transition back to reduced capabilities (DPS Transition Delay), before the end of the TXOP. In some embodiments, after receiving an acknowledgement for any frames sent to the AP, the non-AP STA may also transmit a null data packet, a new frame, or the DPS Wakeup Request frame, with sufficient MAC padding included to protect the medium for a time sufficient for the AP's transition back to the reduced capabilities (DPS Transition Delay). In some embodiments, the frame may be transmitted on the full bandwidth of the TXOP. In some embodiments, the frame may be transmitted on the primary 20 MHz channel of the AP.

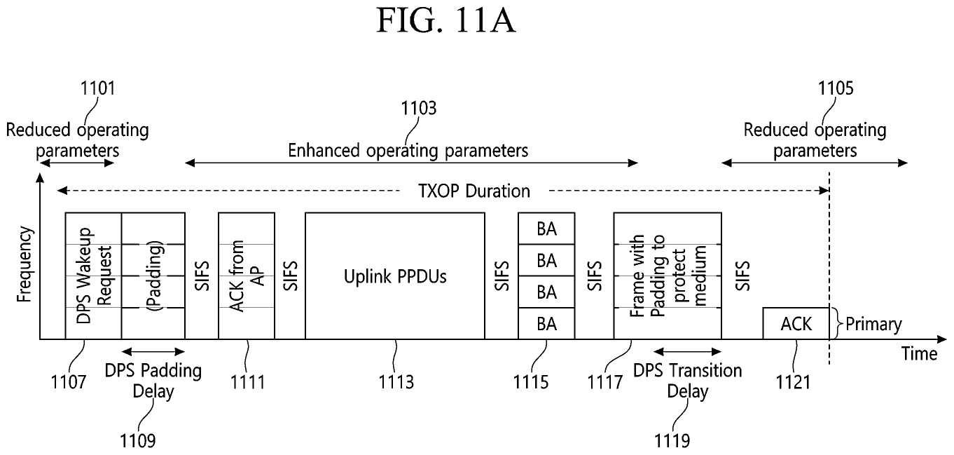

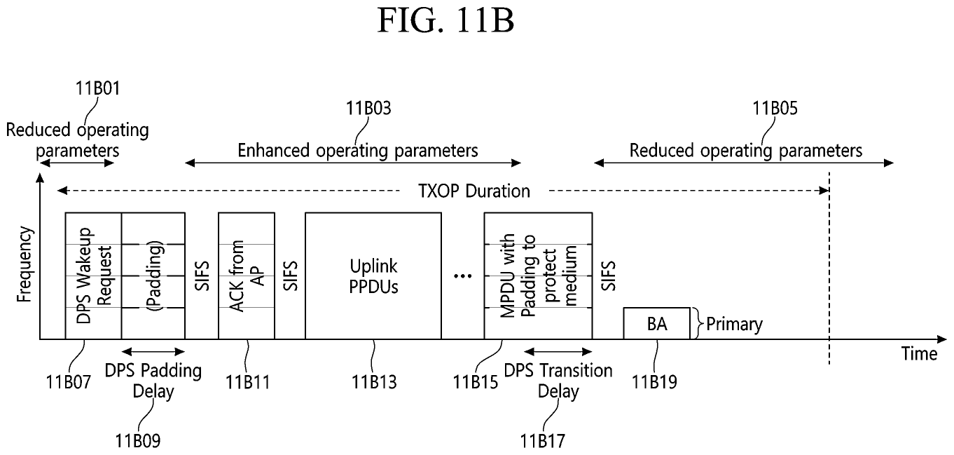

FIG. 11A illustrates protection of medium for transition back to reduced operating parameters after uplink transmission using a follow-up frame in accordance with an embodiment. As illustrated, the AP is operating in DPS mode and the AP is expected to transition from enhanced operating parameters 1103 to reduced operating parameters 1105 at the end of the TXOP. Initially, the AP is operating with reduced operating parameters 1101 and receives a DPS wakeup request frame 1107 that includes padding with the DPS padding delay for the AP to transition from the reduced to enhanced operating parameters 1103. After a SIFS, the AP transmits an ACK frame 1111. After SIFS, the AP receives uplink PPDUs 1113. After an SIFS, the AP transmits BA 1115. The AP receives from the non-AP STA a frame 1117 with padding to protect the medium for a time sufficient for the AP's transition back to the reduced capabilities (DPS Transition Delay 1119). After the transition to reduced capabilities, the AP may transmit an ACK frame 1121 for the null data packet, new frame, or the DPS Wakeup Request frame on the primary 20 MHz channel or at the smaller of: (i) the TXOP bandwidth and (ii) the AP's reduced operating bandwidth, or the frame may not solicit an ACK response. Note that although this procedure is shown as the last operation of the TXOP in FIG. 11A, this may even be performed in the middle of the TXOP after completing some frame exchanges or in the beginning of the TXOP.

In some embodiments, the padding required for the transition (DPS Transition Delay) may just be included in the last frame transmitted by the TXOP owner to the AP. Correspondingly the AP may perform the transition to reduced operating parameters during the padding and the acknowledgement may be sent on the primary 20 MHz bandwidth or may be sent on the smaller of (i) the TXOP bandwidth and (ii) the reduced bandwidth of the AP (corresponding to the reduced operating parameters).

FIG. 11B illustrates the protection of medium for transition back to reduced operating parameters after uplink transmission using padding in an uplink frame in accordance with an embodiment. Note that here last frame can also be an aggregated MAC Protocol Data Unit (A-MPDU), and the padding can be provided by a null MPDU that is included in the A-MPDU. Note that although this procedure is shown as the last operation of the TXOP here, this may even be performed in the middle of a TXOP after completing some frame exchanges or in the beginning of a TXOP. As illustrated, the AP is operating in DPS mode and the AP is expected to transition from enhanced operating parameters 11B03 to reduced operating parameters 11B05 at the end of the TXOP. Initially, the AP is operating with reduced operating parameters 11B01 and receives a DPS wakeup request frame 11B07 that includes padding with the DPS padding delay 11B09 for the AP to transition from the reduced operating parameters 11B01 to enhanced operating parameters 11B03. After a SIFS, the AP transmits an ACK frame 11B11. After SIFS, the AP receives uplink PPDUs 11B13. The AP receives from the non-AP STA an MPDU frame 11B15 with padding to protect the medium for a time sufficient for the AP's transition back to the reduced capabilities (DPS Transition Delay 11B17). After the transition to reduced operating parameters 11B05, the AP may transmit a BA frame 11B19 for the null data packet, new frame, or the DPS Wakeup Request frame on the primary 20 MHz channel or at the smaller of: (i) the TXOP bandwidth and (ii) the AP's reduced operating bandwidth, or the frame may not solicit an ACK response.

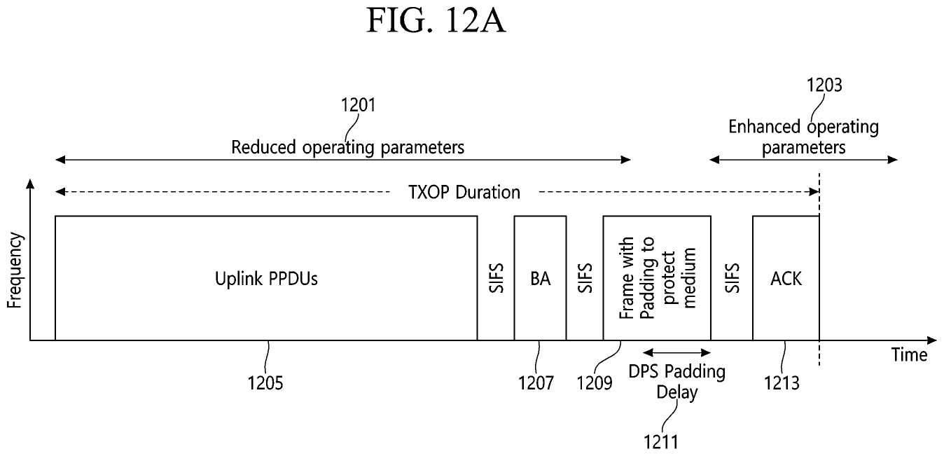

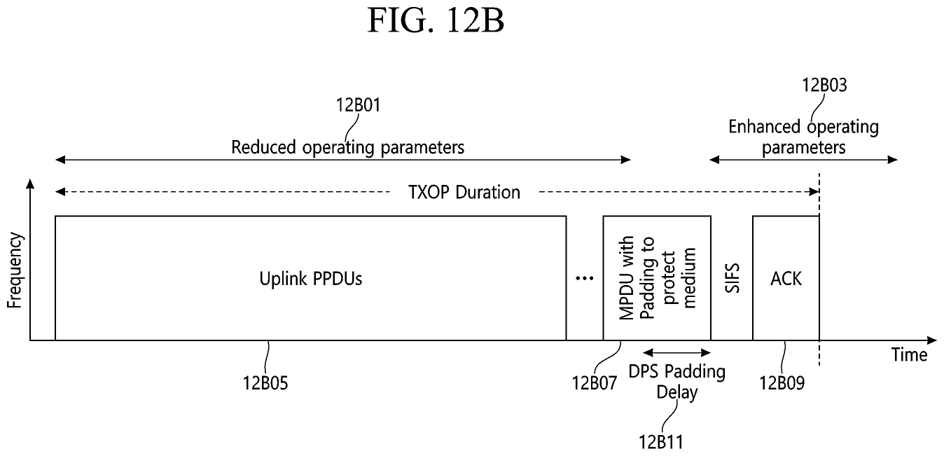

In some embodiments, when a non-AP STA (that supports DPS operation) initiates a transmission with an AP operating in DPS mode and the AP is expected to transition from reduced capabilities to enhanced capabilities at the end of the transmission, then the non-AP STA can end its transmission such that there is sufficient time for the AP to transmit an acknowledgement for the transmission (if required) and also transition to enhanced capabilities (DPS Padding Delay), before the end of the TXOP. In some embodiments, after receiving an acknowledgement for any frames sent to the AP, the non-AP STA may also transmit a null data packet, a new frame, or the DPS Wakeup Request frame, with sufficient MAC padding included to protect the medium for a time sufficient for the AP's transition to the enhanced capabilities (DPS Padding Delay). In some embodiments, the frame may be transmitted on the full bandwidth of the TXOP as depicted in FIG. 12A.

FIG. 12A illustrates the protection of medium for transition from reduced to enhanced operating parameters after uplink transmission using a follow-up frame in accordance with an embodiment. As illustrated, the AP is operating with reduced operating parameters 1201, during which the AP receives uplink PPDUs 1205. After an SIFS, the AP transmits a BA 1207. After an SIFS, the non-AP STA transmits a frame 1209 with padding to protect the medium for a time sufficient for the AP's transition to the enhanced operating parameters 1203 (DPS Padding Delay 1211). After the transition to enhanced capabilities, the AP may transmit an ACK frame 1213.

In some embodiments, the padding required for the transition (DPS Padding Delay) may just be included in the last frame transmitted by the TXOP owner to the AP. Correspondingly the AP may perform the transition to the enhanced operating parameters during the padding and the acknowledgement may be sent on the primary 20 MHz bandwidth or may be sent on the full TXOP bandwidth.

FIG. 12B illustrates the protection of medium for transition from reduced to enhanced operating parameters after uplink transmission using padding in an uplink frame in accordance with an embodiment. Note that here last frame can also be an A-MPDU, and the padding can be provided by a null MPDU that is included in the A-MPDU.

As illustrated in FIG. 12B, the AP is operating with reduced operating parameters 12B01, during which the AP receives uplink PPDUs 12B05. The non-AP STA transmits an MPDU 12B07 with padding to protect the medium for a time sufficient for the AP's transition to the enhanced operating parameters 12B03 (DPS Padding Delay 12B11). After the transition to enhanced operating parameters 12B03, the AP transmits an ACK frame 12B09.

In some embodiments, the AP may indicate within the TXOP its intention to transition to reduced or enhanced operating parameters at the end of the TXOP. The AP may also indicate one or more STAs that the AP requests to assist with protecting the medium while the AP transitions from the enhanced operating parameters to the reduced operating parameters or from the reduced operating parameters to the enhanced operating parameters. These STAs may be among the STAs that have indicated support for DPS operation. When the AP is the TXOP responder, such indications can be included in a field of the acknowledgement frame sent by the AP. This may be beneficial for the non-AP STA (that supports DPS operation) to determine if the AP is expected to transition to reduced capabilities in the middle or the end of the transmission and if the STA is supposed to transmit the null data packet, a new frame, or the DPS Wakeup Request frame.

Note that although the above procedures have been mentioned for the case where the AP is a TXOP responder, all, or some of them may also be applicable for the case where the AP is the TXOP initiator, and the non-AP STAs are performing triggered uplink transmissions. They may also be applicable for the case where the AP is the TXOP owner, but the TXOP has been shared with the non-AP STA via triggered TXOP sharing procedure.

Selecting the medium protection mechanism to use in accordance with this disclosure is described herein. In some embodiments, when an AP operating in DPS mode makes a determination to perform a transition of its DPS state, it may have multiple options for the protection of the medium, including: i) wait for sniffing a packet on the medium for which it is neither the TXOP owner nor responder; ii) wait for an uplink frame from an associated STA to pursue the state transition as a TXOP responder; or iii) contend to win channel access and perform medium protection as the TXOP owner, among others.

In some embodiments, each type of medium protection mechanism can have different overheads in terms of reliability, power consumption, latency of switch, among other overheads. Correspondingly, an AP may make an internal implementation specific decision on the mechanism to use. In some embodiments, an AP may set a threshold time T, and wait for that time to see if there is a packet on the air using which it can perform the state transition. If no such frame is observed, the AP may initiate a contention for the channel access for performing the state transition as a TXOP owner. In some embodiments, the AP may immediately initiate a contention for channel access after determining the need to switch DPS state. If the medium becomes busy due to transmissions not meant for the AP, the AP can follow the medium protection mechanism meant for the neither TXOP owner nor responder case. If the medium becomes busy due to transmissions addressed to the AP, the AP can follow the medium protection mechanism meant for the TXOP responder case. If the AP wins the medium contention, the AP can follow the medium protection mechanism meant for the TXOP owner case.

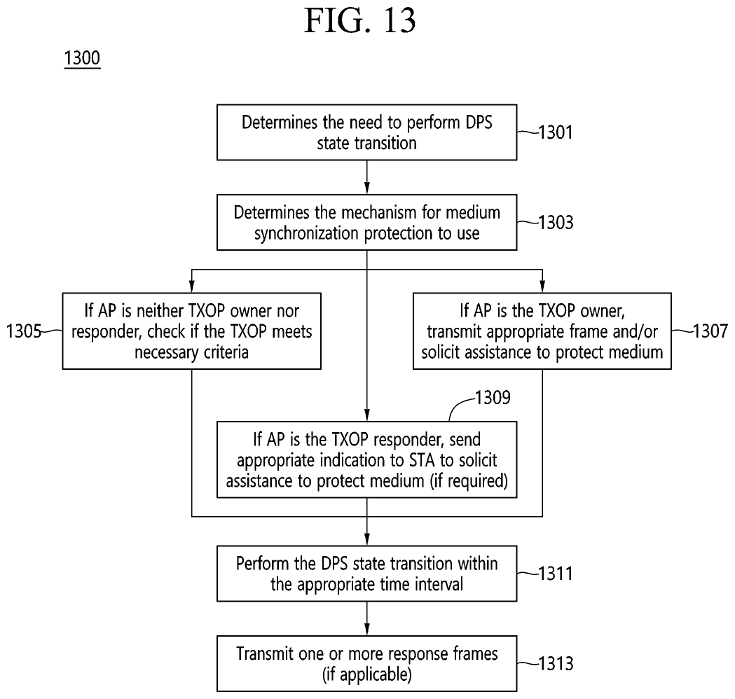

FIG. 13 illustrates a flow chart of an example process of an AP when performing DPS state transition in accordance with an embodiment. Although one or more operations are described or shown in particular sequential order, in other embodiments the operations may be rearranged in a different order, which may include performance of multiple operations in at least partially overlapping time periods. The flowchart depicted in FIG. 13 illustrates operations performed in an AP, such as the AP illustrated in FIG. 3.

In particular, FIG. 13 illustrates a flow diagram illustrating the sequence of steps performed by an AP for changing its DPS state without loss of medium synchronization. The process 1300, in operation 1301, the AP determines the need to perform a DPS state transition.

In operation 1303, the AP determines the mechanism for medium synchronization protection to use. In some embodiments, when an AP operating in DPS mode makes a determination to perform a transition of its DPS state, it may have multiple options for the protection of the medium, including i) wait for sniffing a packet on the medium for which it is neither the TXOP owner nor responder, ii) wait for an uplink frame from an associated STA to pursue the state transition as a TXOP responder, or iii) contend to win channel access and perform medium protection as the TXOP owner, among others.

In operation 1305, if the AP is neither the TXOP owner nor responder, the AP checks if the TXOP meets a necessary criteria. In some embodiments where the AP is initially in reduced parameters state and intends to transition to enhanced parameters state, if the AP is able to detect the preamble of a frame that is not addressed to it and for which the Network Allocation Vector (NAV) time is longer than the DPS Padding Delay, the AP may perform the transition during the duration of that TXOP. In some embodiments where the AP is initially in the enhanced parameters state and intends to transition to reduced parameters state, if the AP is able to detect the preamble of a frame that is not addressed to it and for which the Network Allocation Vector (NAV) time is longer than the DPS Transition Delay, the AP may perform the transition during the duration of that TXOP. In some embodiments, the preamble of a PPDU may need to satisfy some constraints for the AP to be able to use it to perform the transition. Such constraints can be based on, for example, the BSS Color of the PPDU, signal power of the detected preamble, the format of the detected PPDU, the PPDU duration, the spatial reuse flag of the PPDU, among other constraints.

In operation 1307, if the AP is the TXOP owner, the AP transmits an appropriate frame and/or solicits assistance to protect the medium. In some embodiments where the AP is initially in reduced parameters state and intends to transition to enhanced parameters state, upon winning a TXOP the AP may transmit a CTS-to-self frame in non-HT format to set the Network Allocation Vector (NAV) for a duration of at least a DPS Padding Delay beyond the end of the CTS-to-self frame and may then transition to the enhanced operating parameters during this time. This procedure may prevent associated STAs which can hear the AP from initiating transmission to the AP during the transition, thus preventing loss of frames.

In some embodiment where the AP intends to change its DPS state, upon winning a TXOP the AP may first transmit a frame to a non-AP STA that supports DPS operation with an indication that the AP intends to change its DPS state. The transmitted frame may include an indication of one or more of an indication that the AP is soliciting padding in response frame, an identifier of the non-AP STA from whom padding is solicited, an indication of the reason for the padding, the required duration of the padding, the current DPS state of the AP, the new DPS state of the AP, or required transmission bandwidth of the response frame. In the response frame, the non-AP STA can include sufficient padding to protect the medium till AP performs the transition of the DPS state (DSP Padding Delay for transition from reduced to enhanced parameters and DPS Transition Delay for transition from enhanced to reduced parameters).

In operation 1309, if the AP is the TXOP responder, the AP sends appropriate indications to an STA to solicit assistance to protect medium, if required. In some embodiments, when a non-AP STA (that supports DPS operation) initiates a transmission with an AP operating in DPS mode and the AP is expected to change its DPS state at the end of the transmission, then the non-AP STA can end its transmission such that there is sufficient time for the AP to transmit an acknowledgement for the transmission (if required) and also change the DPS state (DPS Padding Delay for transition from reduced to enhanced parameters and DPS Transition Delay for transition from enhanced to reduced parameters), before the end of the TXOP.

In operation 1311, the AP performs the DPS state transition within the appropriate time interval.

In operation 1313, the AP transmits one or more response frames, if applicable. In some embodiments, after the change in DPS state, the AP may transmit an ACK frame for the null data packet, new frame, or the DPS Wakeup Request frame on the primary 20 MHz channel or the full bandwidth of the TXOP, or the frame may not solicit an ACK response.

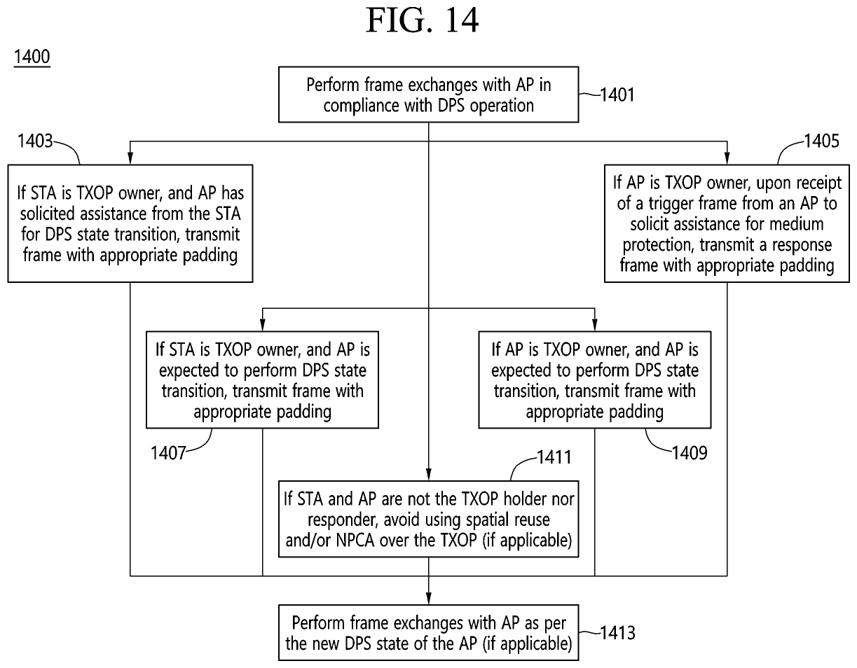

FIG. 14 illustrates a flow chart of an example process of a DPS-supporting STA when the AP (that it is associated with) performs DPS state transitions in accordance with an embodiment. Although one or more operations are described or shown in particular sequential order, in other embodiments the operations may be rearranged in a different order, which may include performance of multiple operations in at least partially overlapping time periods. The flowchart depicted in FIG. 14 illustrates operations performed in an STA, such as the STA illustrated in FIG. 3.

The process 1400, in operation 1401, the STA performs frames exchanges with an AP in compliance with DPS operation.

In operation 1403, if the STA is the TXOP owner, and the AP has solicited assistance from the STA for the DPS state transition, the STA transmits a frame with appropriate padding. In some embodiments, in the frame, the non-AP STA can include sufficient padding to protect the medium till AP performs the transition from the reduced to the enhanced operating parameters (DSP Padding Delay) or the enhanced to the reduced operating parameters (DPS Transition Delay).

In operation 1405, if the AP is the TXOP owner, upon receipt of a trigger frame from the AP to solicit assistance for medium protection, the STA transmits a response frame with appropriate padding. In some embodiments, in the frame, the non-AP STA can include sufficient padding to protect the medium till AP performs the transition from the reduced to the enhanced operating parameters (DSP Padding Delay) or the enhanced to the reduced operating parameters (DPS Transition Delay).

In operation 1407, if the STA is the TXOP owner, and the AP is expected to perform DPS state transition, the STA transmits a frame with appropriate padding. In some embodiments, in the frame, the non-AP STA can include sufficient padding to protect the medium till AP performs the transition from the reduced to the enhanced operating parameters (DSP Padding Delay) or the enhanced to the reduced operating parameters (DPS Transition Delay).

In operation 1409, if the AP is the TXOP owner and the AP is expected to perform DPS state transition, the STA transmits a frame with appropriate padding. In some embodiments, in the frame, the non-AP STA can include sufficient padding to protect the medium till AP performs the transition from the reduced to the enhanced operating parameters (DSP Padding Delay) or the enhanced to the reduced operating parameters (DPS Transition Delay).

In operation 1411, if the STA and the AP are not the TXOP holder nor responder, the STA avoids using spatial reuse and/or NPCA over the TXOP, if applicable.

In operation 1414, the STA performs frame exchanges with the AP as per the new DPS state of the AP, if applicable.

In some embodiments, the AP may have limited or no transmit capabilities when operating in the reduced capability state. Correspondingly, the AP may require some time to enable its transmitter, known as the DPS Transmission Delay. In some embodiments, it may be ensured that this delay is smaller than a SIFS duration, so that the AP is capable of sending a response frame within a SIFS duration of receiving any frame addressed to it. In some embodiments, the aforementioned mechanisms for transition as a TXOP owner, responder or neither, can also be extended to consider three or more capability states. In some embodiments, the states can be: i) reduced capability state with Transmitter OFF; ii) reduced capability state with Transmitter ON; or iii) Enhanced capability state with Transmitter ON.

In some embodiments, if the Transmit capabilities are unavailable at the AP in a DPS state, the AP may use the mechanisms defined under TXOP responder or neither TXOP holder nor responder, for turning the transmitter ON.

Embodiments in accordance with this disclosure can provide mechanisms that prevent loss of medium synchronization at an AP during DPS state transitions, improving wireless communications and allowing an AP to save power without degrading the performance of latency sensitive traffic.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, comprising:
a memory; and
a processor coupled to the memory, the processor configured to:
operate in a first state of a dynamic power saving mode;
determine a capability to transition to a second state of the dynamic power saving mode; and
transition to the second state of the dynamic power saving mode during a network allocation vector (NAV) duration.

2. The AP of claim 1, wherein:
the first state is a reduced operating parameter state and the second state is an enhanced operating parameter state;
the first state is the enhanced operating parameter state and the second state is the reduced parameters state; or
the first state is a reduced operating parameter state without transmit capability and the second state is a reduced operating parameter state with transmit capability.

3. The AP of claim 1, wherein the processor is further configured to:
detect a preamble of a frame that is not addressed to the AP and the NAV duration is associated with the frame.

4. The AP of claim 1, wherein the processor is further configured to:
transmit a frame to set the NAV for at least a time period required to transition to the second state.

5. The AP of claim 1, wherein the processor is further configured to:
transmit, to a station (STA), a first frame indicating that the AP intends to transition from the first state to the second state; and
receive, from the STA, a second frame in response to the first frame, the second frame including a padding, wherein the AP transitions to the second state on or before an end of the padding.

6. The AP of claim 1, wherein the processor is further configured to:
receive, from a station (STA), a frame that includes a padding, wherein the AP transitions to the second state on or before an end of the padding.

7. The AP of claim 6, wherein the frame is transmitted on a full bandwidth of a transmission opportunity (TXOP) or on a primary 20 MHz bandwidth of the TXOP.

8. The AP of claim 6, wherein the processor is further configured to:
transmit, to the STA, an acknowledgement frame in response to the frame.

9. The AP of claim 1, wherein the processor is further configured to:
apply one or more transmission parameters associated with a current state to which the AP belongs.

10. A station (STA) in a wireless network, comprising:
a memory; and
a processor coupled to the memory, the processor configured to:
receive, from an access point (AP), a first frame indicating that the AP intends to transition from a first state to a second state of a dynamic power saving mode; and
transmit, to the AP, a second frame in response to the first frame, the second frame including padding, wherein the AP transitions to the second state on or before an end of the padding.

11. The STA of claim 10, wherein the processor is further configured to transmit, to the AP, a third frame to indicate one or more of
a capability of supporting dynamic power saving operation at the AP; and
a capability of transmitting frames for providing medium protection for the AP's dynamic power saving state transitions.

12. The STA of claim 10, wherein the processor is further configured to:
receive, from the AP, an acknowledgement frame in response to the second frame.

13. A computer-implemented method for wireless communication by an access point (AP) in a wireless network, comprising:
operating in a first state of a dynamic power saving mode;
determining a capability to transition to a second state of the dynamic power saving mode; and
transitioning to the second state of the dynamic power saving mode during a network allocation vector (NAV) duration.

14. The computer-implemented method of claim 13, wherein:
the first state is a reduced operating parameter state and the second state is an enhanced operating parameter state;
the first state is the enhanced operating parameter state and the second state is the reduced parameters state; or
the first state is a reduced operating parameter state without transmit capability and the second state is a reduced operating parameter state with transmit capability.

15. The computer-implemented method of claim 13, further comprising:
detecting a preamble of a frame that is not addressed to the AP and the duration is associated with the frame.

16. The computer-implemented method of claim 13, further comprising:
transmitting a frame to set the NAV for at least a time period required to transition to the second state.

17. The computer-implemented method of claim 13, further comprising:
transmitting, to a station (STA), a first frame indicating that the AP intends to transition from the first state to the second state; and
receiving, from the STA, a second frame in response to the first frame, the second frame including a padding, wherein the AP transitions to the second state on or before an end of the padding.

18. The computer-implemented method of claim 13, further comprising:
receiving, from a station (STA), a frame that includes a padding, wherein the AP transitions to the second state on or before an end of the padding.

19. The computer-implemented method of claim 18, wherein the frame is transmitted on a full bandwidth of a transmission opportunity (TXOP) or on a primary 20 MHz bandwidth of the TXOP.

20. The computer-implemented method of claim 18, further comprising:
transmitting, to the STA, an acknowledgement frame in response to the frame.
